(19) United States
(12) Patent Application Publication
(10) Pub. No.: US 2026/0354650 A1
(43) Pub. Date: Nov. 12, 2026

(54) HEATED MOP BUCKET

(71) Applicant: Lydia Aley, Greenville, PA (US)

(72) Inventor: Lydia Aley, Greenville, PA (US)

(21) Appl. No.: 19/202,299

(22) Filed: May 8, 2025

(51) Int. Cl. A47L 13/50; F24H 1/00; F24H 1/18; F24H 15/223; G01K 1/14; G01K 3/00

(52) U.S. Cl. CPC A47L 13/50; F24H 1/0072; F24H 1/185; F24H 15/223; G01K 1/14; G01K 3/005

(57) ABSTRACT

A heated mop bucket to store water therein such that the heated mop bucket is useable with a mop, the heated mop bucket including a bucket main body outer portion forming an outer shell of the heated mop bucket, a clean water compartment disposed at a front portion of the heated mop bucket, and configured to store the water therein when the water is clean, a dirty water compartment to store the water therein when the water is dirty, and a bucket base disposed at a bottom portion of the heated mop bucket, the bucket base including heating coils disposed inside or on the bucket base to heat the bucket base to a predetermined temperature, such that the heat is transferred to the water stored within the clean water compartment.

### BACKGROUND

### 1. Field

The present general inventive concept relates generally to a mop bucket, and particularly, to a heated mop bucket.

### 2. Description of the Related Art

Mop and bucket systems are common household items that allow a person to effectively and conveniently clean a floor by using water disposed within the bucket, and then cleaning the floor with the mop.

However, even if hot water is initially poured into the bucket, the water eventually loses its warmth, thus causing a user to clear the floor with cold water.

Therefore, there is a need for a mop and bucket system that keeps water warm within a bucket.

### SUMMARY

The present general inventive concept provides a heated mop bucket.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a heated mop bucket to store water therein such that the heated mop bucket is useable with a mop, the heated mop bucket including a bucket main body outer portion forming an outer shell of the heated mop bucket, a clean water compartment disposed at a front portion of the heated mop bucket, and configured to store the water therein when the water is clean, a dirty water compartment disposed at a rear portion of the heated mop bucket to store the water therein when the water is dirty, and a bucket base disposed at a bottom portion of the heated mop bucket, the bucket base including heating coils disposed inside or on the bucket base to heat the bucket base to a predetermined temperature, such that the heat is transferred to the water stored within the clean water compartment.

The heated mop bucket may further include an electrical portion disposed on a surface of the bucket main body outer portion to be electrically connected to the heating coils, such that the electrical portion controls a heating of the heating coils to the predetermined temperature.

The electrical portion may include a keypad disposed at a front surface of the electrical portion to allow a user to input the predetermined temperature, a display unit disposed at the front surface of the electrical portion to display the predetermined temperature input by the user, a temperature sensor disposed at a rear portion of the electrical portion to sense a temperature of the water, and a central processing unit (CPU) to control the heating coils to heat to a particular heating level based on the predetermined temperature input by the user, and based on the temperature of the water sensed by the temperature sensor, such that the predetermined temperature of the water is reached andmaintained.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front angled perspective view of a heated mop bucket, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Mop 10
Water 20
Heated Mop Bucket 100
Bucket Main Body Outer Portion 110
Handle 111
Draining Nozzle 112
Draining Nozzle Cap 112a
Sliding Partition 113
Clean Water Compartment 120
Mop Holder 121
Minimum Water Level Line 122
Dirty Water Compartment 130
Strainer 131
Bucket Base140
Heating Coils 141
Electrical Portion 150
Display Unit 151
Keypad 152
Temperature Sensor 153
Indicator Light 154
Power Switch 155
Battery 156
Charging Port 157
Central Processing Unit (CPU) 158
Wheels 160

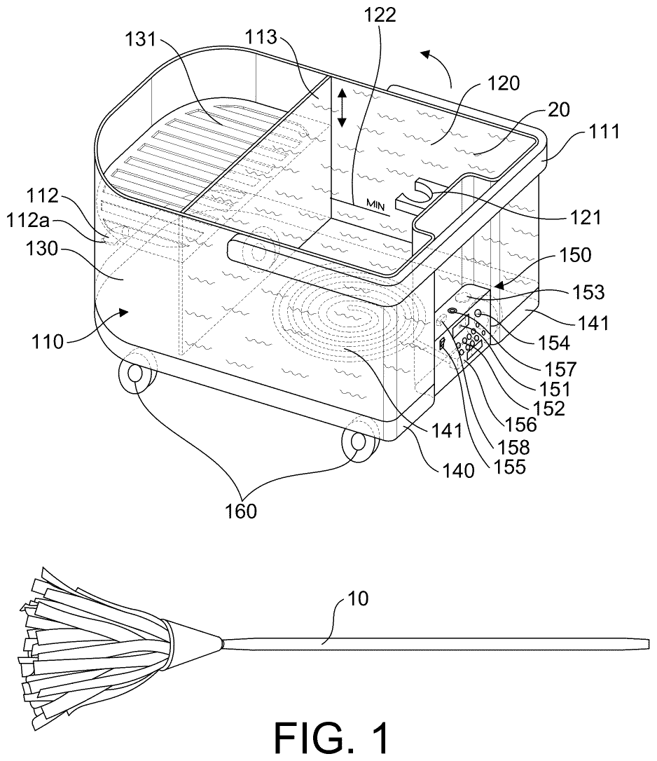

FIG. 1 illustrates a front angled perspective view of a heated mop bucket 100, according to an exemplary embodiment of the present general inventive concept.

The heated mop bucket 100, and all components therein, may be constructed from at least one of wood, plastic, paper, metal, silicone, liquid, fibers, threads, fabric, foam, sponge, nylon, vinyl, feathers, glass, adhesives, circuitry, coils, and rubber, etc., but is not limited thereto, and can be constructed from any material known to one of ordinary skill in the art.

The heated mop bucket 100 may include a bucket main body outer portion 110, a clean water compartment 120, a dirty water compartment 130, a bucket base 140, electrical portion 150, and a plurality of wheels 160, but is not limited thereto.

The bucket main body outer portion 110 may include a handle 111, a draining nozzle 112, and a sliding partition 113, but is not limited thereto.

The handle 111 may be swivably attached to an upper portion of the bucket main body outer portion 110, and may be configured to allow a user to easily lift the heated mop bucket 100.

The draining nozzle 112 may be provided on a rear portion of the bucket main body outer portion 110 at the dirty water compartment 130 near the bucket base 140, to allow any dirty water collected in the dirty water compartment 130 to be expelled from the dirty water compartment 130 through the draining nozzle 112 when a draining nozzle cap 112a is removed from the draining nozzle 112.

The sliding partition 113 may be removably disposed within an inner portion of the heated mop bucket 100 to divide the clean water compartment 120 from the dirty water compartment 130.

The clean water compartment 120 may include a mop holder 121, and a minimum water level line 122, but is not limited thereto.

The clean water compartment 120 may be disposed at a front portion of the heated mop bucket 100, and may be configured to store water 20 within an inner portionthereof.

The mop holder 121 may be disposed within the clean water compartment 120, and may allow a mop 10 to be securely held and attached within the inner portion of the clean water compartment 120.

The minimum water level line 122 may be disposed within the inner portion of the clean water compartment 120 to indicate a minimum amount of the water 20 that should be poured into the clean water compartment 120.

The dirty water compartment 130 may be disposed at a rear portion of the heated mop bucket 100, and may be configured to store dirty water therein.

The strainer 131 may be disposed within the dirty water compartment 130 to allow a user to strain the water 20 from the mop 10 when the water 20 becomes dirty after the mop 10 has cleaned a dirty floor, for example.

The bucket base 140 may include heating coils 141, but is not limited thereto.

The heating coils 141 may be disposed within or on a top surface of the bucket base 140, and may be disposed within the clean water compartment 120.

The heating coils 141 may be electrically connected to the electrical portion 150, so that the electrical portion 150 may cause the heating coils 141 to heat to a predetermined temperature as desired by a user.

The bucket base 140 may be constructed from a material that is heat resistant so that the bucket base does not melt when the heating coils 141 become heated.

The heating coils 141 may heat the bucket base 140 to a predetermined temperature, such that the heat is transferred to the water 20 stored within the clean water compartment 120.

The electrical portion 150 control the heating coils 141, and may include a display unit 151, a keypad 152, a temperature sensor 153, an indicator light 154, a power switch 155, a battery 156, a charging port 157, and a central processing unit (CPU) 158, but is not limited thereto.

The electrical portion 150 may be disposed at a front surface of the bucket main body outer portion 110, but is not limited thereto.

The display unit 151 may be disposed on a front portion of the electrical portion 150, and may be any type of display screen known to one of ordinary skill in the art, including, but not limited to, a touch screen, an LED screen, an OLED screen, an LCD screen, a plasma screen, etc. The display unit 151 may be configured to display a temperature the water 20 disposed within the clean water compartment 120.

The keypad 152 may be used to allow a user to enter a temperature of the water 20 desired by the user, and may include a plurality of number keys ranging from 0 through 9, and may also include an “ENTER” button to allow the input temperature to be set by the user. For example, if the user wants the water to be 120-degrees, the user may press the keys “1”, “2”, “0”, “ENTER”, which may cause the heating coils 141 to heat up until the water 20 reaches 120 degrees.

The temperature sensor 153 may be disposed at a rear portion of the electrical portion 150, so that the temperature sensor 153 may sense a temperature of the water 20 stored within the clean water compartment 120.

The indicator light 154 may be disposed at a front portion of the electrical portion 150, and may turn on (i.e., illuminate) when a temperature of the water 20 preset by the user is reached.

The power switch 155 may allow a user to power-on and/or power-off the electrical portion 155.

The battery 156 may supply power to the electrical portion 150 when the power switch 155 is pressed to a position to power-on the electrical portion 150.

The charging port 157 may allow the battery 156 to be charged when the charging port is plugged into an outlet, adapter, USB port, or any other type of port known to one of ordinary skill in the art known to be able to charge a battery.

The CPU 158 may may be disposed within the electrical portion 150, and may include electronic circuitry to carry out instructions of a computer program by performing basic arithmetic, logical, control and input/output (I/O) operations specified by the instructions. The CPU 158 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The CPU 158 may also include a microprocessor, controller, and a microcontroller. The CPU 158 may be a local computer device, a remote server, or cloud computing device.

The CPU 158 may also include a storage unit, a random access memory (RAM), a read-only memory (ROM), a hard disk, a flash drive, a database connected to the Internet, cloud-based storage, Internet-based storage, or any other type of storageunit.

The CPU 158 may access the Internet via an internal communication unit to allow the CPU 158 to access a website, and/or may allow for communication with a mobile application and/or a software application. The communication unit may include various wireless capabilities including, but not limited to, WIFI, Bluetooth, cellular, near field communications (NFC), etc. For ease of description, the mobile and/or the software application will be hereinafter referred to as an app. The app may be downloaded from the Internet to be stored on the storage unit of the CPU 158.

The CPU 158 may also have a global positioning service (GPS) device installed therein, to allow the CPU 158 to be located via a GPS signal.

The CPU 158 may provide instructions between all of the components within the

[symbol]

The CPU 158 may allow a predetermined temperature input by a user via the keypad 152 (and displayed on the display unit 151) to be set so that the heating coils 141 begin to heat up so that the heat from the heating coils 141 is transferred to the water 20. Also, the CPU 158i may control the temperature sensor 153 to sense a temperature of the water 20 as the heating coils 141 are heated and may stop or reduce the heating-op of the heating coils 141 when the predetermined temperature of the water 20 is reached, thus also causing the indicator light 154 to illuminate. If a temperature of the water 20 begins to cool down, the CPU 158 causes the heating coils 141 to continue to heat at a predetermined heating level so that the desired temperature of the water 20 is maintained.

The plurality of wheels 160 may be provided in any number desired by a manufacturer, and may be disposed at a bottom surface of the bucket base 140.

The present general inventive concept may include a heated mop bucket 100 to store water 20 therein such that the heated mop bucket 100 is useable with a mop 10, the heated mop bucket 100 including a bucket main body outer portion 110 forming an outer shell of the heated mop bucket 100, a clean water compartment 120 disposed at a front portion of the heated mop bucket 100, and configured to store the water 20 therein when the water 20 is clean, a dirty water compartment 130 disposed at a rear portion of the heated mop bucket 100 to store the water 20 therein when the water 20 is dirty, and a bucket base 140 disposed at a bottom portion of the heated mop bucket 100, the bucket base 140 including heating coils 141 disposed inside or on the bucket base 140 to heat the bucket base 140 to a predetermined temperature, such that the heat is transferred to the water 20 stored within the clean water compartment 120.

The heated mop bucket 100 may further include an electrical portion 150 disposed on a surface of the bucket main body outer portion 110 to be electrically connected to the heating coils 141, such that the electrical portion 150 controls a heating of the heating coils 141 to the predetermined temperature.

The electrical portion 150 may include a keypad 152 disposed at a front surface of the electrical portion 150 to allow a user to input the predetermined temperature, a display unit 151 disposed at the front surface of the electrical portion 150 to display the predetermined temperature input by the user, a temperature sensor 153 disposed at a rear portion of the electrical portion 150 to sense a temperature of the water 20, and a central processing unit (CPU) 158 to control the heating coils 141 to heat to a particular heating level based on the predetermined temperature input by the user, and based on the temperature of the water 20 sensed by the temperature sensor 153, such that the predetermined temperature of the water 20 is reached and maintained.

The present general inventive concept is designed to enhance cleaning efficiency and safety by keeping water warm or hot for longer durations. The present general inventive concept incorporates heating coils within the bucket to maintain the water temperature, allowing for more effective dirt removal, degreasing, and improved hygiene. Hot water is crucial for dissolving dirt and grease, and it also helps to kill bacteria. The present general inventive concept includes features like easy water drainage, mobility, and a rechargeable battery, making the cleaning process more convenient and faster. It is ideal for both home and industrial cleaning, offering a practical solution to time-consuming and inefficient traditional methods. The bucket is equipped with heating coils that keep the water warm, ensuring that cleaning remains effective over time. A sturdy handle is attached to the bucket, providing comfort and control during use, making it easy to carry and maneuver. The heating base is where the coils are situated, providing the necessary heat to keep the water at an optimal temperature for cleaning. This feature alerts the user when the water reaches a certain temperature, ensuring that the water is neither too hot nor too cold for cleaning. The present general inventive concept includes a charging port for recharging the battery, enabling the system to operate cordlessly and enhancing its portability. A screen displays important information such as the water temperature, allowing the user to monitor the status of the system. The battery powers the heating system and provides mobility, eliminating the need for a power outlet during use. A simple on/off switch to control the operation of the system, offering ease of use. The wheels ensure smooth movement, even when the bucket is full, making it easier to transport. The dirty water compartment of the bucket holds used water, keeping it separate from clean water and ensuring proper hygiene. The nozzle allows easy draining of dirty water, and the plug seals the compartment when not in use.

A strainer filters debris as water drains, ensuring that the drainage system remains clear and functional. This partition helps organize the bucket, keeping clean and dirty water separate, improving both convenience and hygiene. A guideline to indicate the minimum water level for optimal operation, preventing overheating and ensuring efficient heating. The clean water compartment holds fresh water for cleaning, making sure it stays separate from the dirty water and is ready for use. The present general inventive concept solves several issues commonly encountered in traditional cleaning methods. One of the most significant benefits is that the system keeps water warm for extended periods, improving cleaning efficiency. Hot water has greater kinetic energy, helping to dissolve dirt, grease, and bacteria more effectively. This feature reduces the need for frequent water changes, saving time and resources. The system also includes a safety feature that monitors the temperature of the water. The light alarm alerts the user when the water is too hot or has reached an ideal temperature, preventing burns and ensuring safety. This is especially beneficial for households with children or pets. Another major advantage is the convenient drainage system. The present general inventive concept allows users to easily dispose of dirty water without needing to lift and carry the entire bucket. This feature is especially useful in reducing the physical strain of cleaning, as it eliminates the need for manual dumping of the water. Additionally, the system's mobility—thanks to the rechargeable battery and heavy-duty wheels—makes it ideal for cleaning larger areas without the limitations of a power cord. The present general inventive concept is designed for versatility, catering to both home and industrial cleaning needs. Whether for floors, walls, or other surfaces, the heated water and drainage features make it suitable for various cleaning applications. In conclusion, the present general inventive concept offers a unique solution to common cleaning challenges. Its ability to maintain hot water for efficient cleaning, combined with its mobility and safety features, makes it a valuable tool for both household and commercial use. By reducing cleaning time, improving hygiene, and offering convenience, this system provides a practical and efficient way to tackle cleaning tasks, making it an essential addition to any cleaning toolkit.

The present general inventive concept is unique because it combines a heating mechanism with a mobile design, allowing water to remain warm for longer periods, which enhances cleaning efficiency. Unlike traditional systems where water quickly cools, the heated base ensures that the water stays hot, improving the effectiveness of cleaning by dissolving dirt, grease, and bacteria more effectively. Additionally, it features a convenient drainage system, rechargeable battery for mobility, and safety measures like a temperature sensor and light alarm, making it a versatile, time-saving, and safer solution for both home and industrial cleaning.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A heated mop bucket to store water therein such that the heated mop bucket is useable with a mop, the heated mop bucket comprising:
a bucket main body outer portion forming an outer shell of the heated mop bucket;
a clean water compartment disposed at a front portion of the heated mop bucket, and configured to store the water therein when the water is clean;
a dirty water compartment disposed at a rear portion of the heated mop bucket to store the water therein when the water is dirty; and
a bucket base disposed at a bottom portion of the heated mop bucket, the bucket base comprising:
heating coils disposed inside or on the bucket base to heat the bucket base to a predetermined temperature, such that the heat is transferred to the water stored within the clean water compartment.

2. The heated mop bucket of claim 1, further comprising:
an electrical portion disposed on a surface of the bucket main body outer portion to be electrically connected to the heating coils, such that the electrical portion controls a heating of the heating coils to the predetermined temperature.

3. The heated mop bucket of claim 2, wherein the electrical portion
comprises: a keypad disposed at a front surface of the electrical portion to allow
a user to input the predetermined temperature;
a display unit disposed at the front surface of the electrical portion to display the predetermined temperature input by the user;
a temperature sensor disposed at a rear portion of the electrical portion to sense a temperature of the water; and
a central processing unit (CPU) to control the heating coils to heat to a particular heating level based on the predetermined temperature input by the user, and based on the temperature of the water sensed by the temperature sensor, such that the predetermined temperature of the water is reached and maintained.
